(19) United States
(12) Patent Application Publication
(10) Pub. No.: US 2015/0177408 A1
(43) Pub. Date: Jun. 25, 2015

(54) METHOD FOR MEASURING THE ACTIVITY OF A PHOTON EMISSION SOURCE

(71) Applicant: INSTITUT RADIOPROTECTION ET DE SURETTE NUCLEAIRE, Fontenay-Aux-Roses (FR)

(72) Inventors: Fabien Panza, Paris (FR); Rodolfo Gurrarian, Palaiseau (FR)

(73) Assignee: INSTITUT DE RADIOPROTECTION ET DE SURETE NUCLEAIRE, Fontenay-Aux-Roses (FR)

(21) Appl. No.: 14/415,127

(22) PCT Filed: Jul. 19, 2013
(86) PCT No.: PCT/EP2013/065266

§ 371 Date: Jan. 15, 2015

(30) Foreign Application Priority Data
Jul. 19, 2012 (FR) 1257004

(51) Int. Cl. G01V 5/02; G01N 23/22; G01T 1/36

(52) U.S. Cl. CPC G01V 5/02; G01T 1/36; G01N 23/2206

(57) ABSTRACT

The invention relates to a method for a study of a photon emission source at a site, the method including the steps consisting of: measuring (100) the spectrometric data and the geographic coordinates of the measurement point at a surface point of said site and storing said data in association with said coordinates in a memory; moving (200) the detector to at least one other point of the site and, at each point, repeating the step of measuring and storing; and implementing a deconvolution step (500), using a predetermined detector response function, on all the measured spectrometric surface data, in order to obtain refined spectrometric surface information, said spectrometric surface information enabling the geographic location and the evaluation of the photon emission rate of said source. The invention further relates to a system suitable for implementing the method.

### FIELD OF THE INVENTION

The invention relates to the field of acquisition and processing of spectrometric data, to determine the characteristics of a gamma type electromagnetic radiation source of any nature (ore, pollution, sealed sources) of a given site.

Characterizing this source comprises locating and quantizing the activity of the radiation source.

### STATE OF THE ART

There are several types of site contamination, such as a surface deposition of polluting elements, leaks related to the circulation of a contaminated fluid, or even the presence of a buried electromagnetic radiation source.

The radiations themselves can be variable. They can be gamma rays, in the case of a radioactive source, X or infrared rays.

The contamination types correspond to different radiation emission profiles in the ground and decontamination procedures.

The object of the measurement campaigns carried out on a contaminated site is to determine, knowing the contamination type, the location and volume of the radiation source, in order to determine its photon emission rate (or activity in the case of a radioactive source).

However, such campaigns generally only give access to the surface radioactive activity of the site. In order to deduce the desired information regarding the contamination from this surface activity, activity profile models and hypotheses on the ground type are used.

For example, with reference to FIG. 1, the activity curve of a radioactive element is shown as a function of the depth at a given time, when the presence of the radioactive element comes from a surface deposit.

The activity A as a function of the depth z can be an exponential function the expression of which is given as follows:

$$A ( z ) = {A}_{0} {e}^{- ( \frac{ρ}{β} ) z}$$

where A₀ is the surface specific activity, ρ is the ground density in kg·m⁻³, and β is the relaxation mass coefficient, in kg·m⁻². The latter coefficient characterises the depth distribution of the radioactive source in the ground.

In order to find the total activity present in the ground, the counting rate is measured on a given energy range of the energy spectrum, and hypotheses on the ground constitution are chosen, i.e. the ground is modelled and a density ρ is provided to it, and a hypothesis on the value of β is put forward, in order to deduce therefrom the depth activity profile.

Then this measured counting rate is multiplied by the inverse of the detector response function in order to obtain the total activity value, which corresponds to the initially deposited activity at the ground surface. This response function is conventionally calculated from the knowledge of the radioactivity distribution in the ground.

However, this calculating method of the ground activity requires to start from the hypothesis of a homogeneous ground contamination, that is a photon emission source extending on a very large surface with respect to the detector. This hypothesis is erroneous in the cases where the source is a point source. This method is also quite inaccurate since it is based on a hypothesis concerning the value of β, which sometimes proves to be erroneous or at least inaccurate. Through this method, a systematic inaccuracy therefore exists on the value of the total activity present in the ground.

Furthermore, if contamination is not homogeneous or if the detector is directly above a boundary between a healthy zone and a contaminated zone, this inaccuracy is increased by the measurement of the surface activity itself. Indeed, the detectors detect all the surrounding gamma radiations, and not only those coming vertically from the subsoil on the measurement sites.

As a result, the photons can come from zones where the ground parameters are different from the site measured directly under, and therefore the determined total activity can be erroneous since the measurement of the site surface activity is a combination of several distributions.

### DISCLOSURE OF THE INVENTION

The purpose of the invention is to overcome the above mentioned problems. Particularly, one of the purposes of the invention is to provide a method for determining the outlines of a radiation source at a site, in order to quantize the activity of said source with increased accuracy.

Another purpose of the invention is to provide a method further enabling the depth distribution of the source to be determined.

In this regard, the invention provides a method for studying a photon emission source at a site, the method comprising the steps of:
measuring the spectrometric data and the geographic coordinates of the measurement point at a surface point of said site and storing said data in association with said coordinates,
moving the detector to at least one other point of the site and, at each point, repeating the step of measuring and storing, and
implementing from a predetermined detector response function a deconvolution step, on all the measured spectrometric surface data, in order to obtain refined spectrometric surface information,

the refined spectrometric surface information enabling the geographic location and the evaluation of the photon emission rate of said source.

Advantageously, but optionally, the invention can further comprise at least one of the following characteristics:
the spectrometric data is a photon counting rate in a determined energy band characteristic of an atomic species of the source, and a photon counting rate in a second energy band, corresponding to photons of said atomic species scattered by Compton scattering;
the method further comprises a step of remeshing the measured spectrometric data, prior to the deconvolution step, during which a network of evenly distributed points is generated, and spectrometric data is determined at the points of the network as a function of the spectrometric data acquired at the measurement points;
the detected radiations are gamma rays, and the method further comprises a step of determining a relaxation mass coefficient of the source at the site from the spectrometric information at each measurement point or at each point of the network;
the step of determining a relaxation mass coefficient comprises, at each measurement point or at each point of the network, the calculation of a ratio of the photon counting rate of the first energy band to the photon counting rate of the second energy band.
The method further comprises the steps of:
   deducing from the relaxation mass coefficient a depth distribution in the ground of said source, and
   determining the detector response function as a function of the depth distribution of said source.
The refined spectrometric surface information comprises the activity of the photon emission source at each point of the site, said activity being obtained by the deconvolution of the spectrometric data by the detector response function.
The method further comprises the step of:
   calculating, from the activity map, a photon flow at the surface of the site,
   comparing said flow to at least one measured flow at the surface of the site, and
   repeating the steps of calculating a relaxation mass and deconvolution coefficient, in order to obtain a convergence between the calculated flow and the measured flow.
The method further comprises a step of carrying out a cartography of the activity of the photon emission source on the site.

The invention also relates to a system for detecting radioactive activity suitable for implementing the method according to the invention, the system comprising:
a mobile cart, suitable for being moved in a site,
a radiation detector, mounted on said cart, suitable for measuring spectrometric data at a plurality of measurement points,
a calculation and processing unit, and
a memory in communication with the calculating and processing unit,

the system being characterised in that the processing unit is suitable for:
loading data of each measurement point stored in the memory,
from a predetermined detector response function, implementing a deconvolution step on all said data, in order to obtain refined spectrometric surface data, and
generating a cartography of a photon emission source at the origin of the spectrometric data present in said site.

Advantageously, but optionally, the system according to the invention can further comprise at least one of the following characteristics:
the positioning device is a global positioning system.
The detector is a germanium detector, and the detection system further comprises a cooling system comprising a liquid nitrogen tank.

The use of a deconvolution method of the spectrometric measurements by the detector response function which is calculated with a method of determining a depth radioactive activity profile, enables the outlines of a radiation source to be found and its activity to be deduced therefrom.

### DESCRIPTION OF THE FIGURES

Further characteristics, purposes and advantages of the present invention will appear upon reading the following detailed description, with respect to the appended figures, given purely by way of non-limiting example and in which:

FIG. 1, already described, shows a depth radioactive activity profile after the surface deposit of a radioactive contamination.

FIG. 2 schematically shows a system used for implementing a method according to the invention.

FIGS. 3a and 3b show the main steps of the method according to the invention.

FIG. 4 depicts a partial photon emission spectrum.

FIG. 5a shows the relationship between the “Peak to Valley” ratio and the relaxation mass coefficient in the case of a photon source with exponential distribution in the ground and measured by a germanium semi-conductor spectrometer,

FIG. 5b shows the relationship between the “Peak to Valley” ratio and the depth of a photon point source in the ground.

FIGS. 6a, 6b and 6c show an exemplary implementation of a data deconvolution step on a site.

### DETAILED DESCRIPTION OF AT LEAST ONE EMBODIMENT

### Detection System

During the method according to the invention, an operator moves a detection system in a site where at least one photon source is supposedly located.

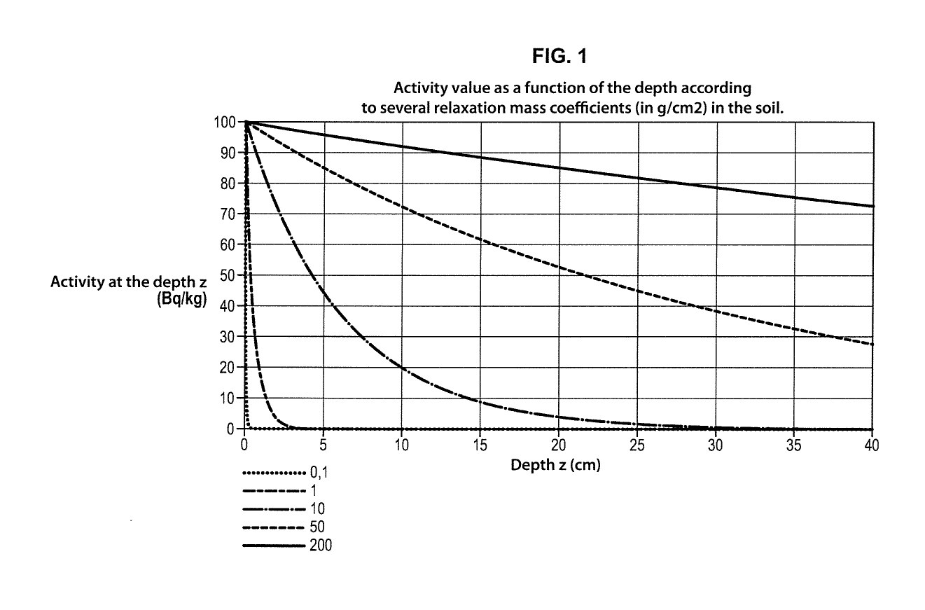

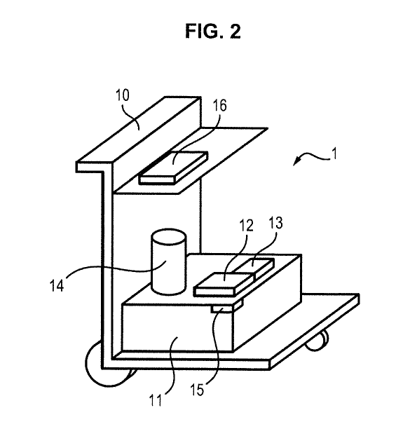

With reference to FIG. 1, such a detection system 1 comprises a mobile cart 10, on which a radiation detector 11 is mounted. The detector is suitable for the studied radiation type; for example in the case of a radioactive source location, the detector is advantageously a germanium detector since it has a very fine resolution, in the order of 0.25% at 600 keV photon energy.

In the case of a germanium detector, it is advantageous to also provide the system with a cooling system 14, for example a liquid nitrogen tank, enabling the detector to be cooled.

This detector is not collimated, such that it can detect photons coming from the ground with a 180° detection aperture, corresponding to a solid angle of 2π steradians.

The system further comprises a calculating and processing unit 12, and a memory 13 connected to said unit. The detector is provided with an interface 15 enabling it to transmit data to the calculating and processing unit.

The system can further comprise a positioning device 16, for example a global positioning system (GPS), connected to the calculating and processing unit, in order to associate with the spectrometric data acquired at a measurement point the geographic coordinates of said point.

### Method for a Study of a Radiation Source

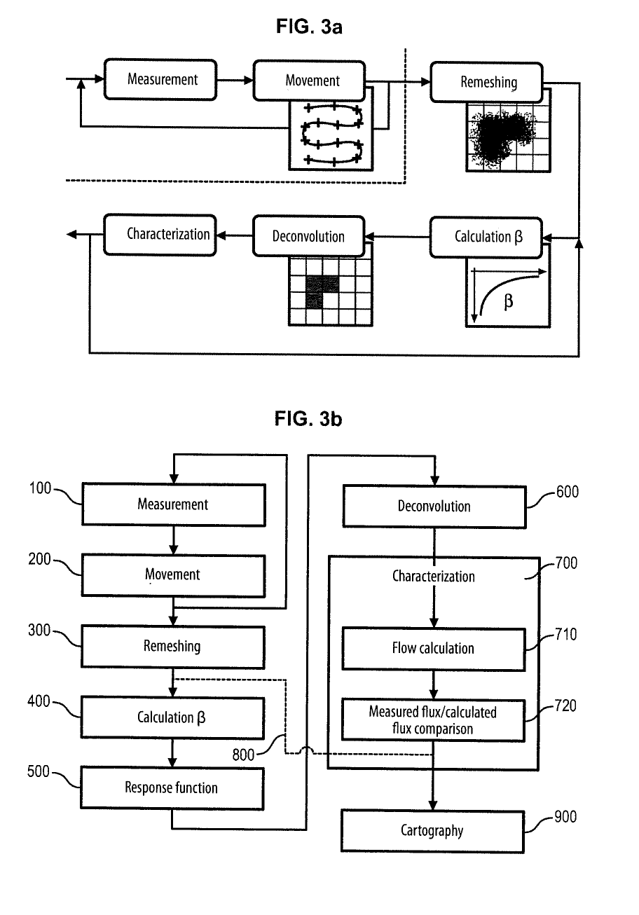

With reference to FIGS. 3a and 3b, the main steps of the method according to the invention are shown.

### Data Acquisition

This method comprises a measurement acquisition part 100 on a site in which a photon emission source S can be located.

During this step of measuring, an operator places a system 1 at a measurement point of the site, and carries out the acquisition 100 of spectrometric data explained below, as well as geographic coordinates of the measurement points.

Each measurement of spectrometric data is recorded by the memory 13. After each step of measuring 100, the operator moves the system 1 in order to reach a new measurement point and repeat the step 100 of acquiring data.

Preferably, the measurement points are evenly distributed on the surface of the site.

The steps of measuring and moving constitute a first part of the method carried out in real time. Once the spectrometric data is acquired for all the measurement points of the considered site, a subsequent phase of reprocessing the data is implemented. This step can be implemented by a server distinct from the system 1 or alternatively by the processing unit 12.

### Data Remeshing

This phase of reprocessing data preferably comprises a step 300 of remeshing the measurement points. This step consists in generating, from a map of the site, a network of evenly distributed points on the site, and in assigning to each point of the network spectrometric data determined from the measured spectrometric data at the measurement points.

This step is carried out by interpolating data collected at the measurement points, in order to obtain spectrometric data corresponding to the geographic coordinates of the network points.

### Determining a Depth Source Profile

Then, a step 400 of determining a depth source profile is implemented. This step depends on the nature of the depth source distribution; punctual or exponential.

In the case of an exponential distribution gamma ray source, this step requires a relaxation mass coefficient β to be determined. This coefficient can be determined in different ways, either by determining a hypothetical coefficient from a hypothesis on the ground constitution, or by calculating it from the spectrometric data at each point.

A method of calculating a relaxation mass coefficient of a gamma ray source having an exponential depth distribution will now be described.

If this step is preceded by a remeshing step, the calculation is carried out on the spectrometric data of the network points. Alternatively, if the step is not preceded by a remeshing, the calculation is carried out on the spectrometric data acquired at each measurement point.

In any case, the calculation of the relaxation mass coefficient comprises the calculation of a ratio, for each measurement point, of the number of detected direct gamma photons to the number of detected gamma photons that have undergone a Compton scattering.

In this regard, the spectrometric data of each utilized point comprise gamma photon counting rates, in counts per second, in different energy bands.

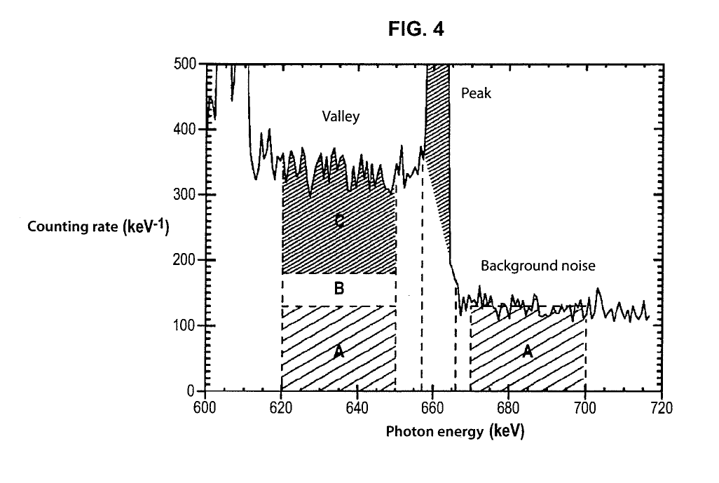

With reference to FIG. 4, part of the photon emission spectrum of an atomic species is shown. This spectrum comprises an energy peak, corresponding to photons emitted by a radioactive source, and reaching the detector without having undergone a scattering. They are called “direct photons”. The largest energy zone on the right of the peak only comprises a background noise at the measurement coming from the natural radioactivity of higher energy radiations (this background noise is considered constant on the studied energy range).

The energy zone on the left of the peak comprises lower energy photons, which are detected after having undergone a Compton scattering and having lost part of the energy at which they are emitted.

This zone more specifically comprises a zone A which corresponds to the background noise on the right of the peak, a zone B which is an additional background noise produced by the heterogeneous Compton background of the higher energy photons, and a zone C which corresponds to the photons that have undergone, in the ground, a Compton scattering at a low scattering angle, thus leading to a low energy loss.

The spectrometric data acquired at each measurement point comprises a photon counting rate in a first energy band at the energy peak, as well as the counting rate of the photons that have undergone a Compton scattering, corresponding to a second energy band.

The area of zone C is determined by subtracting the area of zone A from the background noise and zone B. Then, thanks to the counting rate, the ratio of the net area of the peak to the area of zone C can be calculated.

For further details concerning the calculation implemented to determine this ratio, the publication GERING F. et al. (1998), “In situ gamma spectrometry several years after deposition of radiocesium. II. Peak to valley method”. Radia. EnvironBiophys 37:283-291, can be referred to.

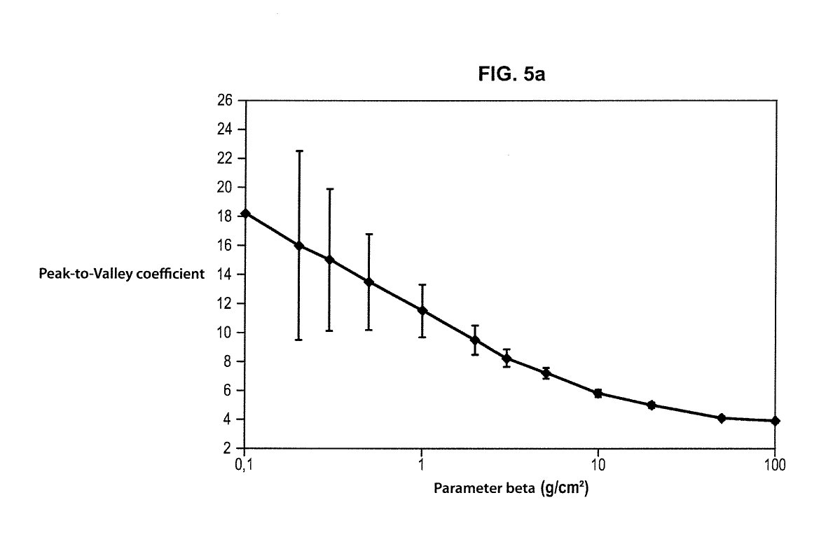

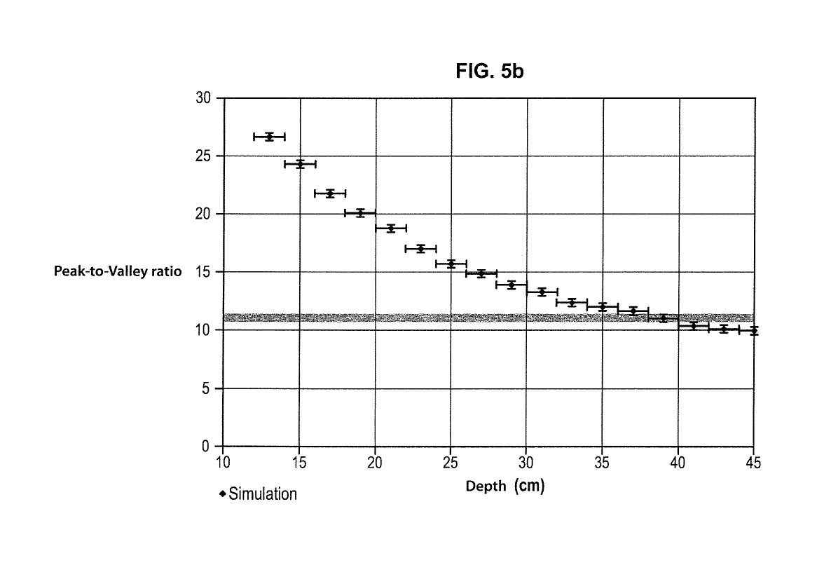

This ratio, called “Peak to Valley”, corresponds to the ratio of the number of direct photons to the number of scattered photons and, as can be seen in FIG. 5a, it is linked to the source depth distribution.

FIG. 5a shows the relationship between a “Peak to Valley” ratio and the value of the relaxation mass coefficient β in the case of an exponential distribution of a gamma ray source. This abacus was made from digital simulations and enables the value of the corresponding relaxation mass coefficient to be found from a Peak-to-Valley ratio.

With reference to FIG. 5b, the Peak-to-Valley ratio is also used in the case of a photon emission point source, since it enables the depth of the source to be obtained. FIG. 5b shows the relationship between the Peak-to-Valley ratio and the depth of a point source. This abacus was also made by digital simulation, and enables the depth of a source to be obtained with accuracy from the value of the Peak-to-Valley ratio.

### Determining the Detector Response Function

The obtained relaxation mass coefficient thus indicates the radionuclide distribution in the ground, and enables the detector response function to be deduced during a step 500 in a manner known by those skilled in the art.

This response function is written

$$G = \frac{{N}_{f}}{A} = \frac{{N}_{f}}{{N}_{0}} \cdot \frac{{N}_{0}}{Φ} \cdot \frac{Φ}{A}$$

where
N_{f} corresponds to the photon counting rate in the considered energy band, in counts/s, and A is the surface or volume activity of the source in Becquerel per square meter or per kilogram, or more generally the surface or volume photon emission rate in counts/s·m² or counts/s·kg.
The term

$$\frac{φ}{A}$$

corresponds to the angular distribution of the photon flow, which solely depends on the radionuclide distribution in the ground, this distribution being obtained by the above determined relaxation mass coefficient.
The term N₀/φ is the photon proportion detected with respect to the flow reaching the detector in a direction parallel to the axis of the detecting crystal thereof.
The term N_{f}/N₀ expresses the variation of the term N₀/φ as a function of the angle of incidence of the photon flow with respect to an axial incident flow.

The surface activity of the source is then obtained by the detector measurements and by its response function, as will be seen below.

### Data Deconvolution

Back to FIG. 3a, this step of determining the detector response function is followed by a deconvolution step 600 of the spectrometric data. This step is carried out either on the data acquired at the measurement points, or on the data obtained at the points of the grating generated during the remeshing step.

Spectrometric data N, that is the photon counting rate on all the energy spectrum picked up by the detector, can be expressed as follows:

N=G [symbol] f

where:
f is the signal (ground emission rate) that one wants to assess or restore, and
G is the spectrometer response function on all the detection spectrum, also named as impulse response, also called point spread function (PSF). It corresponds to the passage function between the activity in the ground of a pixel and the recorded counting rate, and was calculated during the preceding step 500 from the knowledge of the radionuclide distribution in the ground and the detector calibration.

It is therefore noticed that the data collected by the detector is not representative of the exact activity of the site, but are distorted by the detector response function.

Within the context of the invention, the spectrometer response function G represents the recorded number of photons which is obtained with a 1 m² pixel, as a function of its distance to the perpendicular of the detector.

The photon counting rate in the detection spectrum can be written in a matrix term from the writing of the detector response function as follows:

$$N ( {x}_{i} , {y}_{i} ) = ( \frac{{N}_{f}}{{N}_{0}} \cdot \frac{{N}_{0}}{Φ} \cdot \frac{Φ}{A} ) ⊗ A ( {x}_{j} , {y}_{j} )$$

The activity A(xⱼ,yⱼ) at the pixel S(Xⱼ,Yⱼ) produces a counting rate N at a point Sᵢ(Xⱼ,Yⱼ).

In order to conduct the deconvolution step and obtain the real signal f, that is the activity A that one wants to measure, the Richardson-Lucy iterative algorithm is implemented.

The counting rate at each pixel i of the remeshed map can be represented as a convolution of the spectrometer response function G and of the map of the ground radiation emission rate (or activity A) noted:

$${N}_{i} = {G}_{i} ⊗ A ( j ) = {\sum }_{j} {g}_{ij} {A}_{j}$$

with counting rate at the pixel i,

gᵢⱼ: detector response function, applied to the activity of pixel j in order to obtain a counting rate measured at the pixel i, and

Aⱼ: activity of pixel j.

The “maximum likelihood method” of the Aⱼs is used, which give the measured Nᵢs knowing gᵢⱼ. The hypothesis is that the statistics of the ground emission rate follows a Poisson distribution. This leads to an equation that can be iteratively resolved as a function of:

$${A}_{j}^{( t + 1 )} = {A}_{j}^{( t )} {\sum }_{i} \frac{{N}_{i}}{{C}_{i}} {g}_{ij}$$

where t is the iteration index on the activity calculation in pixel j, and

$${C}_{i} = {\sum }_{j} {g}_{ij} {A}_{j}^{( t )}$$

It is showed that if this iteration converges, it converges towards the activity value of pixel “j” causing the part of the counting rate at pixel “i” really corresponding to pixel “j”.

Thus, the deconvoluted data enables the activity of the photon emission source to be directly obtained in a pixel.

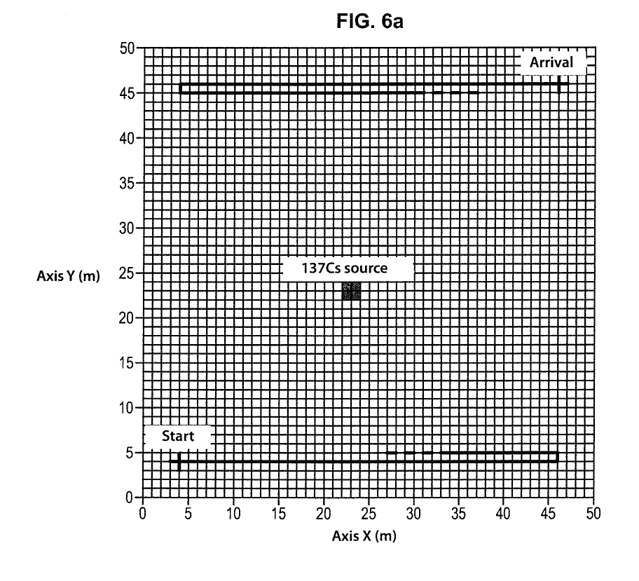

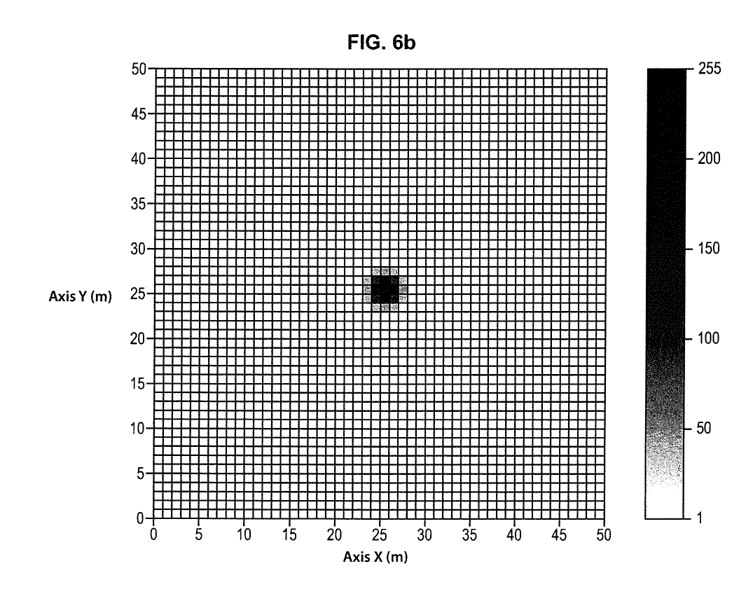

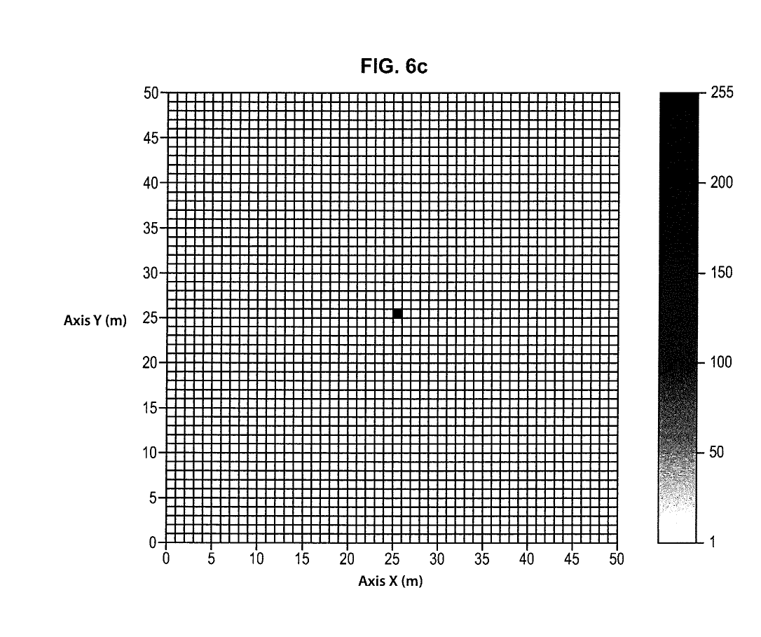

With reference to FIGS. 6a to 6c, an exemplary embodiment of this deconvolution step 600 is shown. FIG. 6a shows a site contaminated by a ¹³⁷Cs radioactive source and the measurement campaign carried out on the site. The source is shown at the centre of the site, and the path of the detector is partially shown, at the start and the arrival. The detector movement is carried out with a one-metre pitch, which is also the acquisition frequency of the measurements, and the distance between two crossings along the axis X of the site.

FIG. 6b shows the data collected by the detector. The grey level of each pixel shows the photon emission rate measured on it. The darker a pixel, the more significant the photon emission rate.

It can be noticed that the counting rate measured by the detector is more spread than the source actually present on the site. The deconvolution step is implemented on this data, in order to obtain the activity shown in FIGS. 6c. It can be noted that the deconvoluted data correspond better to the position and the exact distribution of the source.

### Fine Characterization of the Source

At the end of the deconvolution step, the accurate zones of the site at which the source is present are then obtained, as well as the activity of the source at these points.

Then a step 700 of fine characterization of the source is implemented, which first comprises calculating 710 the photon flow emitted at the surface by the source, as a function of its activity and depth.

The calculated photon flow can be compared to the photon flow actually measured at the surface on the detector during a step 720. If a deviation is noticed, then the steps 400 to 600 can be repeated (arrow 800), specifying the calculation or assessment of the relaxation mass coefficient and specifying the surface on which the source determined by the deconvolution extends.

These steps can be repeated until the convergence of the measured flow and the calculated flow is obtained. Then, during a step 900, the activity obtained at the end of this iteration can be shown on a map of the site, in order to obtain an exact cartography of the presence and activity of the source.

1. A method for a study of a photon emission source at a site, the method comprising the steps of:
measuring (100) the spectrometric data and the geographic coordinates of the measurement point at a surface point of said site and storing said data in association with said coordinates,
moving (200) the detector to at least one other point of the site and, at each point, repeating the step of measuring and storing, and
implementing from a predetermined detector response function a deconvolution step (500), on all the measured spectrometric surface data, in order to obtain refined spectrometric surface information,
the refined spectrometric surface data enabling the geographic location and the evaluation of the photon emission rate of said source.

2. The method according to claim 1, wherein the spectrometric data is a photon counting rate in a determined energy band characteristic of an atomic species of the source, and a photon counting rate in a second energy band, corresponding to photons of said atomic species scattered by Compton scattering.

3. The method according to claim 1, further comprising a step of remeshing (300) the measured spectrometric data, prior to the deconvolution step (500), during which a network of evenly distributed points is generated, and spectrometric data is determined at the points of the network as a function of the spectrometric data acquired at the measurement points.

4. The method according to claim 1, wherein the detected radiations are gamma rays, and the method further comprises a step (400) of determining a relaxation mass coefficient of the source at the site from the spectrometric information at each measurement point or at each point of the network.

5. The method according to claim 4, wherein the step of determining (400) a relaxation mass coefficient comprises, at each measurement point or at each point of the network, the calculation of a ratio of the photon counting rate of the first energy band to the photon counting rate of the second energy band.

6. The method according to claim 4, wherein the step of determining (400) a relaxation mass coefficient comprises, at each measurement point or at each point of the network, the calculation of a ratio of the photon counting rate of the first enemy band to the photon counting rate of the second energy band, the method further comprising the steps of:
deducing from the relaxation mass coefficient a depth distribution in the ground of said source, and
determining the detector response function as a function of the depth distribution of said source.

7. The method according to claim 6, wherein the refined spectrometric surface information comprises the activity of the photon emission source at each point of the site, said activity being obtained by the deconvolution of the spectrometric data by the detector response function.

8. The method according to claim 7, further comprising the step of:
calculating (710), from the activity map, a photon flow at the surface of the site,
comparing (720) said flow to at least one measured flow at the surface of the site, and
repeating the steps of calculating (400) a relaxation mass and deconvolution coefficient (500), in order to obtain a convergence between the calculated flow and the measured flow.

9. The method according to claim 8, further comprising the step of carrying out a cartography (900) of the activity of the photon emission source on the site.

10. A system (1) for detecting radioactive activity suitable for implementing the method according to one of the preceding claims, the system comprising:
a mobile cart (10), suitable for being moved in a site,
a radiation detector (11), mounted on said cart, suitable for measuring spectrometric data at a plurality of measurement points,
a calculation and processing unit (12), and
a memory (13) in communication with the calculating and processing unit, the system being characterised in that the processing unit is suitable for:
loading data of each measurement point stored in the memory,
from a predetermined detector response function, implementing a deconvolution step on all said data, in order to obtain refined spectrometric surface information, and
generating a cartography of a photon emission source at the origin of the spectrometric data present in said site.

11. The detection system according to claim 10, wherein the positioning device (13) is a global positioning system (GPS).

12. The detection system according to claim 10, wherein the detector is a germanium detector, and the detection system further comprises a cooling system (14) comprising a liquid nitrogen tank.
